(19) United States
(12) Patent Application Publication
(10) Pub. No.: US 2026/0180021 A1
(43) Pub. Date: Jun. 25, 2026

(54) ELECTROCHEMICAL CELL WITH A POLYMER-IN-SALT ELECTROLYTE, A SYSTEM COMPRISING THE CELL AND A METHOD OF USING AN ASSOCIATED CATHODE

(71) Applicant: METROL TECHNOLOGY LIMITED, Aberdeen (GB)

(72) Inventors: James Daniel Moloney, Aberdeen (GB); Steven Martin Hudson, Aberdeen (GB); Rumen Tomov, Cambridge (GB); Ramachandran Vasant Kumar, Cambridge (GB); Paulina Librizzi, Aberdeen (GB); Leslie David Jarvis, Aberdeen (GB)

(21) Appl. No.: 19/426,302

(22) Filed: Dec. 19, 2025

(30) Foreign Application Priority Data
Dec. 20, 2024 (EP) 24222654.6

(51) Int. Cl. H01M 10/056; H01M 4/38; H01M 4/583; H01M 4/587; H01M 4/62; H01M 10/052; H01M 10/0587; H01M 10/44

(52) U.S. Cl. CPC H01M 10/056; H01M 4/382; H01M 4/5835; H01M 4/587; H01M 4/62; H01M 4/625; H01M 10/052; H01M 10/0587; H01M 10/44; H01M 2220/10; H01M 2300/0068; H01M 2300/0082; H01M 2300/0091

(57) ABSTRACT

An electrochemical cell having a cathode comprising a fluorinated carbon nanotube (F-CNT), an anode and a solid electrolyte; wherein the solid electrolyte comprises an electrolyte component comprising 50 to 95 wt. % of an alkali metal-containing electrolyte salt, and 5 to 50 wt. % of a polymer. Embodiments do not require a carbon-based conductive-adjuvant in the cathode. The thickness of the solid electrolyte may be least 5 microns. A container comprising cell may have space to allow for thermal expansion thereof. They may be used at elevated temperatures greater than 65° C. or more, such as in a subterranean well.

### FIELD OF THE INVENTION

The present invention concerns the field of alkali metal electrochemical cells and batteries, and in particular solid-state cells and batteries. In particular, the invention relates to cathodes for use with solid polymer-based electrolytes in lithium cells. Aspects of the invention relate to an electrochemical cell comprising solid electrolytes for lithium cells, and the use of such cells at elevated temperatures.

### BACKGROUND OF THE INVENTION

Lithium cells are considered a mature technology. However, current liquid electrolytes for lithium metal batteries are associated with risks such as electrolyte leakage, internal shorting, electrode corrosion, and the production of hazardous by-products; and have a restricted voltage window. The use of solid electrolytes represents one potential solution to the problem of electrolyte leakage and can limit self-discharge within the batteries that shortens the life of a cell. A promising class of solid electrolytes is composite electrolytes, which combine a polymeric electrolyte with an inorganic filler and ionic salt. By “solid” we exclude electrolytes which have liquid or gel components at room temperature and pressure.

Two classes of inorganic fillers have been investigated as additives for use in polymer-based electrolytes: passive fillers and active fillers. Passive fillers do not directly participate in the conduction of ions and include metal oxides such as Al₂O₃, SiO₂, TiO₂, ZrO₂, and BaTiO₃. While passive fillers do not participate directly in the conduction of ions, they do assist in the stability of the conductive amorphous polymer phase by hindering recrystallization of the polymer which can reduce ion conductivity in the polymer matrix. They may under certain circumstances provide interfacial paths for additional ionic conduction.

By contrast, active fillers can directly participate in the conduction of ions through the material and also at the interfaces, while also providing mechanical stability to the amorphous polymer phase. Such active fillers may be referred to as active stabilizers herein. Examples of these active fillers include Li_{1.3}Al_{0.3}Ti_{1.7}(PO₄)₃ (LATP), Li₃N, Li₇La₃Zr₂O₁₂ (LLZO), Li_{0.33}La_{0.557}TiO₃ (LLTO), and Li_{1.4}Al_{0.4}Ge_{1.6}(PO₄)₃ (LAGP), amongst other active fillers.

One of the more promising solid electrolytes is a solid polymer composite electrolyte made from poly(ethylene oxide) (PEO) and LLZO. LLZO used singly by itself as the Solid-State Electrolyte (SSE) can be difficult to process and incorporate in the established cell making and is a brittle material. In a cell this can cause structural failure which risks shorting contact between the cathode and anode, while providing poor contact between the cell electrode and electrolyte. Choi et al (J. Power Sources, Vol. 274, 15 Jan. 2015, pp 458-463) first combined these two materials in a composite electrolyte with tetragonal LLZO as the electrolyte filler and PEO as the matrix and found a maximum conductivity at room temperature of 10⁻⁵ S cm−1.

In 1993 Angell et all (NATURE vol. 362 (1993) pp. 137-139) introduced new composite ionic conductor, namely “polymer-in-salt” materials, in which the amount of Li lithium salts exceeds the quantity of the polymer thus forming “rubbery electrolyte”. These materials preserved good lithium-ion conductivities and high electrochemical stability due to lower glass transitions allowing then to remain rubbery at room temperature. The ionic conductivity in the “polymer-in-salt” materials was shown to be dominated by the Li+ cations and to express transport number close to 0.99.

Patent application CN111009686 discloses an all-solid electrolyte containing a high concentration of lithium salt (LiTFSI) dispersed in a polyvinylidene fluoride-hexafluoropropylene polymer matrix, wherein the content of the lithium salt in the electrolyte is greater than 50 wt. %. Such compositions in which the wt. % of the salt is greater than the wt. % of polymer are known as ‘polymer-in-salt’ solid electrolytes.

Despite various advances, solid-state electrochemical cells typically have poorer conductivity and capacity when compared with more established liquid-state technologies. While the solid electrolytes discussed above go some way to addressing these drawbacks, there remains a need to further improve the electrochemical properties of electrochemical cells that incorporate these solid electrolytes.

The present invention seeks to provide polymer-based solid electrolytes which provide improved metal ion conductivity. It is also an object of the present invention to provide electrochemical cells comprising the solid electrolytes which can be discharged to around 90% or more of their theoretical capacity which for CFx is 865 mAh g⁻¹, where x=1. The invention also seeks to provide solid electrolytes which are thermally stable, i.e. can operate at relatively high temperatures, i.e. from 50° C. to 175° C., preferably 75 to 130° C., without significant degradation, that is, more than 10% increase in on-load source resistance with respect to liquid-state electrolyte, or more than 30% delivered capacity over a period more than 8 years at 130° C.

The present invention also seeks to provide an electrode that is particularly suitable for use with the polymer-based solid electrolytes described herein, and thus provide an improved electrochemical cell incorporating polymer-based solid electrolytes. One or more of these objectives may be satisfied by cathode and electrolyte compositions, and electrochemical cells, as hereinafter described.

### SUMMARY OF THE INVENTION

In accordance with a first aspect of the present invention, there is provided a method of using a cathode for a cell comprising a fluorinated carbon nanotube (F-CNT) at temperatures greater than about 65° C., preferably greater than about 100° C., optionally greater than about 120° C.

Said cathode may be used in a variety of wells including oil and gas wells in general, steam/water injection wells, gas injection wells, geothermal thermal wells, carbon capture and storage (CCS) wells, hydrogen storage wells. In particular, the cathode may be used in geothermal wells or production wells for oil or gas production.

The temperature of use described herein is the environmental temperature and does not take into account any temperature increases caused by operation of the cell. For example, it may be the surrounding temperature immediately before the cell starts to operate.

In accordance with a second aspect of the present invention there is provided an electrochemical cell comprising:
a. a cathode;
b. an anode; and
c. a solid electrolyte;
wherein the cathode is an electrode comprising a fluorinated carbon material, and
wherein the solid electrolyte comprises an electrolyte component and optionally a filler, the electrolyte component comprising:
   i. 50 to 95 wt. % of an alkali metal-containing electrolyte salt, and
   ii. 5 to 50 wt. % of a polymer.

Thus the cell may include the cathode of the first aspect of the invention. Preferred and optional features herein of the cathode and cell independently apply to each of the first and second aspects of the invention and are not reiterated for brevity.

The electrochemical cell may be a solid-state electrochemical cell.

The cell may be provided in a pressure-sealed cylindrical container. It may be 12-35 mm in diameter and may be 50-200 mm long. It is typically hermetically sealed. The container is usually metal such as stainless steel. A plurality of cells in the form of layers may be stacked together to form a battery. The battery may have a circular cross-section.

The cells may be shaped into a bobbin shape or a spiral wound shape.

The cell is preferably pliable to be shaped or rolled into a particular shape, such as said bobbin or spiral wound shapes. Therefore, the cell preferably has a Young's Modulus in the range of 0.5 to 500 MPa at standard temperature and pressure,
preferably measured using a Universal Testing Machine (universal tester) in accordance with ASTM E111-17.

Whilst a single salt is viable in the electrolyte, it may be advantageous to have more than one salt in a mix to make the electrolyte rubbery. For example, using LiTFSI and LiClO₄ salts.

The anode may be connected to the container. The cathode may connect with an electrically insulated penetrator. The electrical insulation may include an elastomer ‘o’ ring, moulded plastic (e.g. peek) sleeve. Preferably it includes a glass to metal seal.

The cell container may define a space adjacent the cell to allow for thermal expansion thereof. It may be, for example, a void (vacuum), an inert gas such as argon, or an inert compressible material such as open cell PTFE foam.

The fluorinated carbon material is a preferably a fluorinated carbon nanotube (F-CNT). Thus, the cathode preferably comprises a fluorinated carbon nanotube (F-CNT). It has surprisingly been found that the use of F-CNT as a cathode material in the electrochemical cell of the invention has certain advantages when compared to the use of other cathode materials, such as fluorinated graphite or fluorinated graphene (CFx).

Without wishing to be bound by theory, it is thought that the fluorinated carbon nanotube (F-CNT) is a source of fluorine which reacts with the alkali metal, such as lithium, to form an alkali fluoride (such as lithium fluoride (LiF)). This reaction is the source of energy in the electrochemical cell.

The solid electrolyte may further comprise 0.1 to 25 wt. % an inorganic active stabilizer, as filler, comprising an alkali metal compound. In some embodiments, the inorganic active stabilizer comprises Li₇La₃Zr₂O₁₂ (LLZO), or a doped variation thereof.

The cation of the inorganic active stabilizer may be the same cation of the alkali metal-containing electrolyte salt, such as lithium.

The cathode may be an electrode comprising:
i) 10⁻⁹⁸ wt. % a fluorinated carbon material (e.g. fluorinated carbon nanotubes (F-CNTs));
ii) 1-45 wt. % an alkali metal-containing salt; and
iii) 1-45 wt. % an organic polymer or copolymer.

More specifically, the cathode may be an electrode comprising:
i) 50-98 wt. %, a fluorinated carbon material (e.g. fluorinated carbon nanotubes (F-CNTs));
ii) 1-35 wt. %, an alkali metal-containing salt; and
iii) 1-35 wt. % an organic polymer or copolymer.

Optionally the electrode may further comprise:
iv) 0.1-15 wt. % of a carbon-based conductive adjuvant, such as carbon-black or a graphite-based carbon. Where present, such a carbon-based-conductive adjuvant may typically be present in an amount of up to 15 wt. %, optionally up to 10 wt. %.

A further aspect of the invention is the use of the electrochemical cell as hereinbefore defined at a temperature of greater than about 65° C., preferably greater than about 100° C. In certain aspects, the electrochemical cell of the invention may be used for powering a tool in a subterranean well, preferably in a subterranean well for oil and/or gas.

### DETAILED DESCRIPTION OF THE INVENTION

Throughout, “conductive” refers to ionic or electronic conduction or both.

The term “solid-state” electrolyte as used herein has its normal meaning in the art, and refers to a system or device in which ionic transport occurs in a solid phase.

The term “solid composite electrolyte” as used herein refers to an electrolyte composition which is solid at ambient temperature and pressure. For the avoidance of doubt, this does not exclude the possibility that when used at elevated temperatures (i.e. temperatures above ambient temperature), the electrolyte composition may become amorphous, semi-solid, gel-like, partially liquid, or wholly liquid.

The second aspect of the present invention is an electrochemical cell comprising:
a. a cathode;
b. an anode; and
c. a solid electrolyte;
wherein the cathode is an electrode comprising a fluorinated carbon material, and
wherein the solid electrolyte comprises:
   1. 50 to 95 wt. % of an alkali metal-containing electrolyte salt, and
   2. 5 to 50 wt. % of a polymer.

The fluorinated carbon material is a preferably a fluorinated carbon nanotube (F-CNT).

The fluorinated carbon material may further comprise one or more additional fluorinated carbon materials, such as those derived from a carbon material selected from the group consisting of activated carbon, coke, pitch coke, charcoal, synthetic or natural carbon fibre, carbon black, graphene, hard carbon, graphite, and composites (carbonizates) or mixtures thereof.

The alkali metal-containing salt is typically a lithium salt, but other alkali metals such as sodium may be used. The electrolyte salt may comprise one or more of: LiClO₄, LiBF₄, LiPF₆, LiAsF₆, LiCF₃SO₃, LiN(CF₃SO₂)₂, NaCF₃SO₃, LiDFOB, LiBOB, a lithium “imide” salt. The lithium imide salt may comprise: Lithium bis(trifluoromethanesulfonyl)imide (LiTFSI) or lithium bis(fluorosulfonyl)imide (LiFSI). A preferred alkali metal-containing electrolyte salt is LiFSI or LiTFSI, more preferably LiTFSI.

The solid electrolyte may be a solid composite electrolyte as hereinbefore defined.

The solid electrolyte as described herein may preferably comprise:
a. 45 to 90 wt. % of an alkali metal-containing electrolyte salt,
b. 5 to 50 wt. % of a polymer, and
c. 0.1 to 25 wt. % of an active or passive inorganic stabilizer comprising an alkali metal compound.

The wt. % detailed for the electrolyte above are determined based on the total mass of the electrolyte. References here to the electrolyte include all components a, b and c whilst references to the polymer include only component b.

In some preferred embodiments of the invention, the solid electrolyte as described herein comprises:
a. 60 to 90 wt. % of an alkali metal-containing electrolyte salt, salt
b. 5 to 35 wt. % of a polymer, and
c. 0.1 to 5 wt. % of an active or passive inorganic stabiliser comprising an alkali metal compound.

The polymer is preferably on organic polymer or copolymer. Suitable organic polymers or copolymers include: poly(ethylene oxide), poly(propylene oxide), poly(dimethylsiloxane), poly(acrylonitrile), poly(methyl methacrylate), poly(vinyl chloride), poly(vinyl acetate), poly(vinylidene fluoride), poly(vinylidene fluoride-hexafluoropropylene), poly[bis(methyoxy-ethoxy-ethoxy) phosphazene, poly(carbonate), poly(phenylene ether), poly(vinylidene fluoride), or blends thereof.

As used herein, the term “EO” refers to ethylene oxide groups (monomers) that may be present in the electrolyte. An example of a electrolyte that contains ethylene oxide groups is poly(ethylene oxide) (PEO).

The organic polymer may comprise a copolymer of two or more monomers. For example the co-polymers may comprise PEO-PAN, PEO-PMMA, PEO-PVDF, PMMA-PVDF, PMMA-PAN, PAN-PVDF, or blends thereof.

For particular embodiments, the organic polymer or copolymer may comprise poly(ethylene oxide) or poly(vinylidene fluoride). Preferably, the organic polymer or copolymer may comprise poly(ethylene oxide).

The polymer for use in the solid electrolyte must be an electronic insulator (i.e. does not permit electronic conduction; has an electronic conductivity of less than about 10⁻¹⁰ ohm⁻¹ m⁻¹, e.g. between about 10⁻²⁰ to 10⁻¹⁰ ohm⁻¹ m⁻¹) but which does permit ion transport. It must have a high room temperature dielectric constant, such as above 3, preferably greater than 10. Without wishing to be bound by theory, this is understood to allow the polymer to solvate the alkali-metal containing electrolyte salt, typically by forming Van der Waals bonds between salt and polymer.

Suitable polymers for use in the solid electrolyte are those that solvate alkali salts, especially lithium salts, in order to conduct alkali ions, especially lithium ions, and such that they are poor electronic conductors. These polymers include: poly(ethylene oxide), poly(propylene oxide), poly(dimethylsiloxane), poly(acrylonitrile), poly(methyl methacrylate), poly(vinyl chloride), poly(vinyl acetate), poly(vinylidene fluoride), poly(vinylidene fluoride-hexafluoropropylene), poly[bis(methyoxy-ethoxy-ethoxy) phosphazene, poly(carbonate), poly(phenylene ether), poly(vinylidene fluoride), or blends thereof.

The polymer may comprise a copolymer of two or more monomers. For example the co-polymers may comprise PEO-PAN, PEO-PMMA, PEO-PVDF, PMMA-PVDF, PMMA-PAN, PAN-PVDF, or blends thereof. In preferred electrolyte compositions the polymer is selected from: poly(vinylidene fluoride-hexafluoropropylene) copolymer, poly(ethylene oxide) or poly(vinylidene fluoride) and blends thereof.

For particular embodiments, the organic polymer or copolymer may comprise poly(ethylene oxide) or poly(vinylidene fluoride). Preferably, the organic polymer or copolymer may comprise poly(ethylene oxide).

For the avoidance of doubt, in the context of the present application, the term “poly(ethylene oxide)” and its abbreviated form “PEO”, also encompasses short-chained PEO, which may be referred to in the art as “poly(ethylene glycol)” or “PEG”.

The polymer may have an average molecular weight (Mw) of at least 10,000 grams per mole, optionally at least 100,000. The average molecular weight (Mw) may be at most 10,000,000 optionally at most 5,000,000 more optionally at most 1,500,000. The polymer for use in the solid composite electrolyte may be substantially amorphous.re

When reference to molecular weight of a polymer or average molecular weight of a polymer is made, this is understood to be the number average molecular weight. That is the total mass of all molecules of the polymer divided by the number of molecules.

The alkali metal-containing electrolyte salt may be an inorganic or organic electrolyte salt.

The alkali metal-containing electrolyte salt is typically a lithium electrolyte salt, but other alkali metals such as sodium may be used. For a lithium based cell, the electrolyte salt may comprise one or more of: LiClO₄, LiBF₄, LiPF₆, LiAsF₆, LiCF₃SO₃, LiN(CF₃SO₂)₂, NaCF₃SO₃, LIDFOB, LiBOB, a lithium “imide” salt. The lithium imide salt may comprise: Lithium bis(trifluoromethanesulfonyl)imide (LiTFSI) or lithium bis(fluorosulfonyl)imide (LiFSI). Preferred alkali metal-containing electrolyte salts are LiClO₄ or LiTFSI. A particularly preferred alkali metal-containing electrolyte salt is LiTFSI.

The inorganic active stabilizer stabilises the electrolyte mechanically. It may be considered as an active, rather than passive filler.

The inorganic active stabilizer typically comprises the same metal ions as that of the alkali metal-containing electrolyte salt ion. Without wishing to be bound by theory, in such cases the inorganic active stabilizer and the electrolyte salt having the same metallic ion may be beneficial for reinforcing ionic conductivity of the said metallic ion.

The inorganic active stabilizer is typically an alkali metal-based ceramic material, preferably lithium-based, which can therefore provide lithium ions which can take part in conduction.

Examples of suitable inorganic active stabilizers for use in the present invention include one or more of: Li_{1.3}Al_{0.3} Ti_{1.7}(PO₄)₃ (LATP), Li₃N, Li₇La₃Zr₂O₁₂ (LLZO), Li_{0.33}La_{0.557}TiO₃ (LLTO), LLZTO, LLAZO, and Li_{1.4}Al_{0.4}Ge_{1.6}(PO₄)₃ (LAGP), a alkali metal garnet, LiAlO₂, Li₁₀GeP₂S₁₂ (LGPS), lithium ion-conducting glass-ceramic (LICGC), Li₂PO₂N (LiPON), Li_{0.5}La_{0.5}TiO₃, Li_{1.4}Al_{0.4}Ti_{1.6}(PO₄)₃, Li_{1.5}Al_{0.5}Ge_{1.5}(PO₄)₃ and Na₃Zr₂Si₂PO₁₂, and doped versions thereof.

The preferred inorganic active stabilizer comprises, or consists of, LLZO preferably doped with for example gallium, strontium, titanium, and/or aluminium. Without wishing to be bound by theory, it is considered that such a dopant helps stabilise the cubic phase which conducts.

In some preferred embodiments of the invention, the LLZO may be nanoparticles of LLZO. That is, in the context of the present disclosure, “nanoparticles” refers to particles with a particle size distribution of d50, optionally d70, optionally d90, optionally d95 of less than 1 micrometre. This may be measured by laser diffraction following ISO 13320:2020. Without wishing to be bound by theory, it is thought that using nanoparticles of LLZO permits greater dispersion of the LLZO within the solid electrolyte without compromising the mechanical stability of the solid electrolyte.

The inorganic active stabilizer may be present in the solid electrolyte in an amount of 0.1 to 25 wt. %, more preferably 0.5 to 10 wt. %, still more preferably 1.0 to 2.0 wt. %, e.g. about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, or about 2.0 wt. %

The conductivity of the finished electrolyte at 60° C. is preferably in the range of between 10⁻⁴ and 10⁻¹ S cm⁻¹, such as about 5.8×10⁻³ S cm⁻¹.

The conductivity of the finished electrolyte at at 90° C. is preferably in the range of between 10⁻⁴ and 10⁻¹ S cm⁻¹, such as about 1.1×10⁻² S cm⁻¹.

The conductivity of the finished electrolyte at 120° C. is preferably in the range of between 10⁻⁴ and 10⁻¹ S cm⁻¹, such as about 7.7×10⁻³ S cm⁻¹.

Alternatively, the conductivity of the finished electrolyte is preferably in the range of between 10⁻⁴ and 10⁻¹ S cm⁻¹ at 60° C.-150° C., such as about 1.1×10⁻² S cm⁻¹ at 90° C.

Without wishing to be bound by theory, it is thought that the inorganic active stabilizer comprising an alkali metal compound stabilizes the electrolyte and provides alkali metal ions which promote conduction thereof through the electrolyte. The inorganic active stabilizer is understood to stabilise the polymer so as to prevent or limit crystallisation, which can adversely affect the ion conductivity of the polymer. The inorganic active stabilizer is also understood to modify the electrolyte by improving ion conductivity. The inorganic active stabilizer preferably has an ability to form Van der Waals bonds with the electrolyte polymer.

The salt may dissolve in the polymer such that the ceramic inorganic active stabilizer may be interspersed in the polymer/salt solid solution. This may be achieved by any suitable method, such as by mixing fine stabilizer and salt particles and dispersing these in the polymer, for example by liquid casting with a solvent that can be evaporated away or by other high-shear force mixing methods. For the avoidance of doubt, other suitable methods may be used to obtain a suitable interspersed mixture of the electrolyte, electrolyte salt and active stabilizer. One preferred method of interspersing the polymer, electrolyte salt and inorganic active stabilizer is by sonication of a mixture of at least two of these components. A further method uses a vacuum centrifugal mixer.

Optionally, the electrode for a solid-state electrochemical cell, may comprise:
i) 70-98 wt. % a fluorinated carbon material comprising fluorinated carbon nanotubes (F-CNTs);
ii) 1-20 wt. % an alkali metal-containing salt; and
iii) 1-20 wt. % an organic polymer or copolymer.

The electrode may also include an inorganic filler. The inorganic filler may be a passive inorganic filler, such as, but not limited to, Al₂O₃, SiO₂, TiO₂, ZrO₂, and BaTiO₃. Alternatively, or additionally, the inorganic filler may be an active inorganic filler, referred to as an active stabilizer, such as (but not limited to) Li_{1.3}Al_{0.3}Ti_{1.7}(PO₄)₃ (LATP), Li₃N, Li₇La₃Zr₂O₁₂ (LLZO), Li_{0.33}La_{0.557}TiO₃ (LLTO), and Li_{1.4}Al_{0.4}Ge_{1.6}(PO₄)₃ (LAGP). Preferably the inorganic filler, where present, is an inorganic active stabilizer comprising Li₇La₃Zr₂O₁₂ (LLZO). Preferably the LLZO is as hereinbefore described in relation to the solid electrolyte.

It has surprisingly been found that in the electrode as hereinbefore described, there is no need for an electron conducting agent (e.g. an additional (adjuvant) conductive carbon source), which is often up to 10% of the mass of the electrode in conventional electrochemical cells. As a result, more active material is embedded in the same electrode volume leading to better gravimetric and volumetric capacity.

Without wishing to be bound by theory, it is thought that the structure of fluorinated carbon nanotubes (F-CNTs) allows for effective percolating paths and thus high electrical conductivity and therefore fulfils this purpose without requiring an additional electron conducting agent.

Preferably, therefore, the electrode does not further comprise a carbon-based conductive adjuvant. Thus certain preferred electrodes for use as a cathode in the electrochemical cell of the invention do not comprise, or consist essentially of, a carbon-based conductive adjuvant. In such cathodes, a carbon-based conductive adjuvant is preferably present in an amount of less than about 10 wt. %, preferably less than about 5 wt. %, more preferably less than about 2 wt. %, still more preferably less than about 1 wt. %, e.g. less than about 0.5 wt. % or less than about 0.1 wt. %.

The electrochemical cell as described herein may comprise a cathode (e.g. an electrode as hereinbefore described) in intimate contact with a solid composite electrolyte as hereinbefore described, and an anode in intimate contact with the electrolyte, where the anode comprises the alkali metal (typically lithium), or an alloy comprising the alkali metal.

The term “intimate contact′” as used herein means contact which permits transfer or permeation of ions (ionic conduction) or electrons (electronic transfer) through the contact interface.

Electrodes, and particularly cathodes, usually also contain some amount of the solid electrolyte, or components thereof. However, in some preferred embodiments of the present invention, the cathode may have between about 5-35 wt. % of the solid electrolyte solution relative to the total electrode incorporated therein. It has surprisingly been found that the incorporation of a specific mass percentage of the salt/polymer solution into the electrode (i.e. cathode) of the invention mitigates the need for the addition of conventionally used binders or improves performance further.

Without wishing to be bound by theory, it is thought that this incorporation of the solid electrolyte solution into the electrode provides a continuous ionic path within the cathode mass.

Thus in preferred electrochemical cells of the invention, the organic polymer or copolymer of the cathode and the polymer of the solid electrolyte comprise the same material. The organic polymer or copolymer of the cathode and the polymer of the electrolyte preferably both comprise poly(ethylene oxide), and more preferably comprise poly(ethylene oxide) of the same Mw.

In addition, the alkali metal-containing salt of the cathode and the alkali metal-containing electrolyte salt of the electrolyte preferably comprise the same material, and more preferably the alkali metal-containing salt of the cathode and the alkali metal-containing electrolyte salt of the electrolyte both comprise LiClO₄, LiBF₄ or lithium bis(trifluoromethanesulfonyl)imide (LiTFSI), more preferably LiTFSI.

In addition, the inorganic active filler of the solid electrolyte and the optional inorganic filler of the cathode preferably comprise the same material, and more preferably comprise Li₇La₃Zr₂O₁₂ (LLZO). Preferably the LLZO is as hereinbefore described in relation to the solid electrolyte.

The anode may comprise carbon electrode material such as lithiated carbon, a metal or metal alloy (preferably alkali metal or alloy) plate or foil. Typically the anode comprises or consists of lithium or a lithium-based alloy or lithium titanate. The anode may comprise an Li-Me alloy material, wherein Me is selected from one or more of Mg, Ca, Al, Si, Ge, Sn, Pb, As, Sb, Bi, Pt, In, Ag, Au, Ti, Zn or Cd; or may be a carbon-containing material, e.g. graphite. These elements may be used to modify chemical or physical properties of the anode, such as to provide a host for Li (e.g. C) or provide capacity from surface reactions (e.g Si, Sn, Pb etc.), increase structural strength (e.g. Al, Mg etc.) or to prevent degradation (e.g. Pt, Au, Ag etc.).

The electrochemical cell may have a generally planar (including a rolled-planar structure), multi-layered configuration. For example, the cathode may provide a proximal planar layer, the solid composite electrolyte may provide an intermediate planar layer juxtaposed the proximal planar layer, and the anode may provide a distal planar layer juxtaposed the intermediate planar layer. The solid composite electrolyte layer is thus, in this case, sandwiched between the proximal and distal electrode layers.

Whilst the thickness of the electrolyte layers is conventionally minimised, in the present invention, the thickness of the solid electrolyte layer may be at least 5 microns, optionally at least 10 microns, more optionally at least 25 microns, even more optionally at least 50 microns, or at least 200 microns. In some embodiments, the thickness of the solid electrolyte layer may be up to 250 microns. The greater the value of the ionic conductivity at the preferred operating temperature, the thicker the electrolyte can be, offering benefits in decreasing self-discharge. In other words, the improved electrochemical properties that result from the combination of the electrode (e.g. cathode) as described herein with the solid composite electrolyte as described herein permits the use of a greater thickness of electrolyte layer than is standard in the art. This greater thickness would normally be undesirable due to the increased resistance and resulting poor performance of a relatively thick electrolyte layer, but the improved conductivity and transport number that result from the combination of the electrode and solid composite electrolyte composition in the electrochemical cell of the invention is such that a functioning cell with sufficient power and low self-discharge can be formed with this thicker layer.

Solid metal terminals may be provided in intimate contact with each of the anode and cathode. These are exposed (or spatially accessible) to permit integration into an electrical circuit.

The electrochemical cell is typically a primary cell (i.e. one which is not rechargeable, or which is intended for a single use).

An electrochemical cell as hereinbefore described may be configured (without limitation) as a bobbin cell, or a spiral wound cell, or as a coin/button cell, pouch cell, or as a flat plate cell.

A further aspect of the invention provides a system comprising an electrochemical cell as hereinbefore described coupled with a power control circuit,
wherein the power control circuit is operable to discharge the electrochemical cell at a first voltage and at a second voltage;
wherein the second voltage is lower than the first voltage; and output terminals electrically connected to the power control circuit for providing the output voltage to a load.

Preferably, the second voltage is at least 20%, preferably at least 50% of the first voltage.

Optionally the second voltage is less than the first voltage, that is less than 100% of the first voltage.

In some preferred embodiments of the system as hereinbefore described, the power control circuit is a DC-to-DC voltage convertor.

Optional and preferred features of the system in accordance with the further aspect of the invention are independently optional and preferred features of the electrochemical cell according to the second aspect of the invention, and these features are not repeated here for brevity.

It has surprisingly been found that the electrochemical cell as described herein can be used to provide lower voltage applications at elevated temperatures (e.g. greater than about 60° C., greater than about 65° C., greater than about 95° C., greater than about 120° C., e.g. between 65 and 150° C.) in order to derive another 800+Wh/Kg of the cathode mass. To take advantage of the additional charge provided by the lower voltage plateau, the electronic circuitry and equipment powered by cells and batteries described herein includes a DC to DC converter to accommodate the roughly 2:1 change in terminal voltage during discharge.

When ‘plateau’ is used to describe the shape of the voltage-capacity profile on discharge, it is used to describe a region wherein the voltage is generally constant with changing capacity. The profile may not be strictly flat and instead has a gradual slope, however it remains distinct from regions wherein the voltage is changing sharply with capacity.

When ‘plateau’ is used to describe the shape of the voltage-capacity profile on discharge, it is used to describe a region wherein the voltage is generally constant with changing capacity. The profile may not be strictly flat and instead may have a gradual slope, however it remains distinct from regions wherein the voltage is changing sharply with capacity. That is +/−15% of the median voltage at >90% of a given capacity range. In other words the voltage is similar over the range, excepting any minor temporary variations, for example as a result of measurement error or measurement tolerance.

In accordance with a further aspect of the invention there is provided a battery comprising a plurality of electrochemical cells as hereinbefore defined arranged in parallel or in series.

In an additional aspect of the invention there is provided a method of manufacturing an electrochemical cell as hereinbefore described comprising providing a liquid precursor of the solid composite electrolyte as hereinbefore described and depositing said liquid precursor as one or more layers on a surface of the cell and causing or allowing the deposited layer(s) to solidify in situ to form the solid composite electrolyte. The layers may be deposited by printing, especially inkjet printing, or other known manufacturing methods. The rheological properties of the precursor is tuned with respect to the deposition method. The liquid precursor includes formulations of inks and soft solids such as pastes, where the amount of liquid to solid ratio is lowered.

The liquid precursor may be a slurry or suspension of solid particles in a liquid carrier. The liquid carrier may comprise a polymer or monomer, which may be dissolved in a solvent. The polymer or monomer may be a solid or a liquid prior to being dissolved in a solvent. Solidification may be by evaporation of the solvent, or by polymerisation of the polymer (or its monomer).

The solid-state electrolyte obviates the need for a conventional separator layer or membrane between the anode and cathode to prevent shorting by offering a physical barrier, and because in absence of a liquid electrolyte, migration of liquid or gel electrolyte is not an issue with solid electrolytes. Thus, a distinct separator layer or membrane may be absent in the cells of the present invention.

In accordance with a further aspect of the invention there is provided the use of an electrochemical cell as hereinbefore defined for powering a tool in a subterranean well such as for oil and/or gas.

A further aspect of the invention is the use of an electrode, an electrochemical cell, or a battery as herein described at a temperature of greater than about 65° C., preferably greater than about 100° C., or greater than about 120° C. Preferably, this use is for powering a tool in a subterranean well for oil, gas, or other hydrocarbons.

Optional and preferred features of the electrode in accordance with the first and second aspects of the invention are independently optional and preferred features of the cathode according to the further aspects of the invention, and these features are not repeated here for brevity.

It has surprisingly been found that the electrode, electrochemical cell and battery of the invention is particularly suitable for use under conditions (e.g. temperature and pressure) that are particularly challenging for existing technologies. In particular, the electrochemical cell and battery of the invention have been found to be stable against degradation and self-discharge at elevated temperatures and/or elevated pressures. This stability is maintained at temperatures of greater than about 65° C., greater than about 95° C., greater than about 120° C., e.g. between 65 and 150° C. Indeed, embodiments of the present invention may function at even higher temperatures, such as 200-250° C.

Without wishing to be bound by theory, it is thought that the solid composite electrolyte as described herein can operate more safely at higher temperatures due to the absence of a liquid solvent, which may be flammable or cause mechanical damage to an electrochemical cell through partial vaporisation or off-gassing. It is also thought that the solid composite electrolyte accommodates volume changes (e.g. expansion) in the electrode (e.g. cathode) throughout cycling of the electrochemical cell and throughout temperature variations in use. This also minimises the impact on the performance of the electrochemical cell (or battery) from any phase changes that may occur in any of the components of the electrochemical cell (or battery) as a result of variations in the operating conditions (e.g. temperature, pressure) during use.

A further aspect of the invention provides a system comprising an electrochemical cell as hereinbefore described coupled with a power control circuit,
wherein the power control circuit is operable to discharge the electrochemical cell at a first voltage and at a second voltage;
wherein the second voltage is lower than the first voltage; and output terminals electrically connected to the power control circuit for providing the output voltage to a load.

Preferably, the second voltage is at least 20%, preferably at least 50%, optionally less than 100% of the first voltage.

In some preferred embodiments of the system as hereinbefore described, the power control circuit is a DC-to-DC voltage convertor.

Optional and preferred features of the system in accordance with the further aspect of the invention are independently optional and preferred features of the electrochemical cell according to one or more earlier aspects of the invention, and these features are not repeated here for brevity.

It has surprisingly been found that the electrochemical cell as described herein can be used to provide lower voltage applications at elevated temperatures (e.g. greater than about 60° C., greater than about 65° C., greater than about 95° C., greater than about 120° C., e.g. between 65 and 150° C.) in order to derive another 800+Wh/Kg of the cathode mass. To take advantage of the additional charge provided by the lower voltage plateau, the electronic circuitry and equipment powered by cells and batteries described herein includes a DC to DC converter to accommodate the roughly 2:1 change in terminal voltage during discharge.

### BRIEF DESCRIPTION OF THE DRAWINGS

Embodiments of the present invention will now be described with references to the accompanying drawings in which:

FIG. 1A is a schematic exploded view of a coin cell with solid state electrolyte. The anode 10a and cathode 30a are placed either side of the electrolyte 20a with a spacer 14 and spring 12 used to ensure even pressure is applied across the surface of the cell. A current collector 32 is provided below the cathode.

FIG. 1B is a schematic exploded view of the layers of a spiral wound cell before they are shaped into a spiral, showing the anode 10b, electrolyte 20b, and cathode 30b with current collector 32. An insulator 16 is provided above the anode 10b.

FIG. 1C is a schematic diagram of the FIG. 1B layers shaped as a spiral in a spiral wound cell.

FIG. 1D is a schematic diagram of a bobbin cell. A central cathode 30c is separated from the anode 10c formed as an outer ring, by the intervening electrolyte 20c.

FIG. 2 shows an Arrhenius plot of derived conductivities for EO:Li electrolytes made with 5,000,000 MW PEO with and without addition of LLZO active inorganic filler.

FIG. 3 shows a plot of the discharge at room temperature (solid) and elevated temperature (dotted) for each, discharged at a rate of 1 mA g⁻¹.

FIG. 4 shows a plot of the discharge at 60° C. (lower curve), 80° C. (middle curve) and 120° C. (upper curve) for cells with “polymer in salt” electrolyte and F-CNT cathode, discharged at a rate of 15 mA g⁻¹.

FIG. 5 shows the FIG. 4 curves with the 120° C. plot fully discharged.

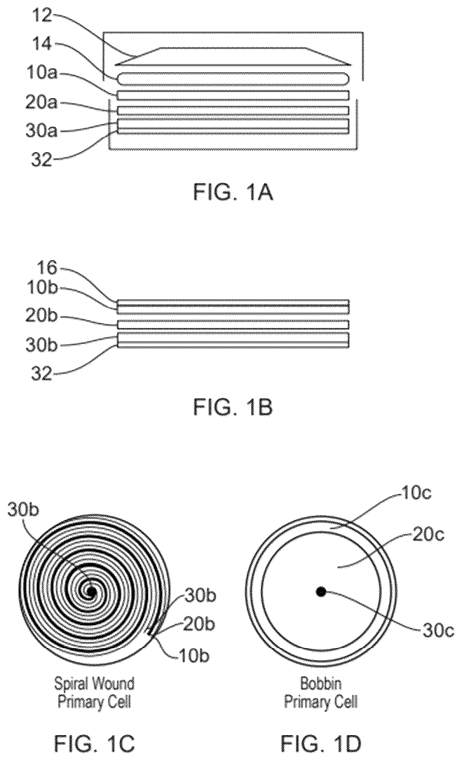

### EXAMPLES

The following is a description by way of example only and with reference to the figures of the drawings of modes for putting the present invention into effect.

### Materials

All materials used are commercially available from known suppliers. Graphite Monofluoride (CFx) and fluorinated carbon nanotubes (F-CNTs) were purchased from ACS Materials. Polyethylene oxide (PEO) with various molecular weights (300,000—approximately 5,000,000 g mol⁻¹) and lithium salts (e.g. Lithium bis(trifluoromethanesulfonyl)imide (LiTFSI)) was purchased from Sigma Aldrich. Lithium lanthanum zirconium oxide (LLZO) was purchased from MSE Supplies.

### Example 1—CFx:PEO:LiTFSI “Polymer in Salt” Cell

To synthesize the “polymer in salt” electrolytes, an appropriate amount of high-molecular weight PEO (e.g. 5,000,000 MW PEO) was measured so that it would achieve the desired EO:Li⁺ ratio with the lithium salt. The PEO and lithium salt were mixed with anhydrous acetonitrile (Sigma Aldrich) and stirred vigorously until no traces of solid PEO could be seen. In some of the cells, LLZO active filler was added so that the mass ratio of LLZO to PEO was 1:9. For comparison, “salt in polymer” electrolyte was prepared with 8:1 EO:Li ratio. The specific weight percentages of LiTFSI (Sigma Aldrich), LLZO and PEO used in this experiment are listed in Table 1. For 1:1 electrolytes the compositions were termed “polymer in salt”, because the mass of LiTFSI salt was greater than 50% of the total mass of the electrolyte.

TABLE 1
Weight percent of salt and base polymer used in “polymer in salt”
and “salt in polymer” electrolytes.

| | 8:1 EO:Li | 1:1 EO:Li | 1:1 EO:Li |
|---|---|---|---|
| | electrolyte | electrolyte | electrolyte |
| | with LLZO | without LLZO | with LLZO |
| PEO | 51.7% | 13.3% | 13.2% |
| LiTFSI | 42.6% | 86.7% | 85.2% |
| LLZO | 5.7% | 0% | 1.6% |

To fabricate the cathode a mix of active material (e.g. CFx) and conductive adjuvant (e.g. carbon black) was mixed in 4:1 mass ratio, ball milled, stirred with PEO/LiTFSI/acetonitrile electrolyte solution and homogenized in ultrasound bath. By mass, the cathode composition was 70.91% CFx, 17.73% Carbon Black, 1.52% PEO, 9.82% LiTFSI, and 0.02% LLZO.

To make a full cell, a 2032 cell cap was filled with about 0.5 g of the cathode mix and allowed to dry in an argon filled glove box at 60° C. The operation was repeated until the desired amount of active cathode material was accumulated. The cathode was topped with electrolyte and dried again at 60° C., with the process being repeated until the cathode was fully covered. The weights of the cathode and the electrolyte were taken after each operation was completed. Lithium foil (16 mm diameter, 1.5 mm thick) was placed on top of the dried electrolyte. Then a stainless steel spacer and a wave spring were placed on top of the lithium foil, and the cell bottom was crimped using 50 kg/cm² of pressure. The cells were allowed to rest overnight before electrochemical testing was undertaken.

Impedance spectroscopy was conducted on a symmetric cell. A lithium foil was placed at the bottom of a 2032 button cell cap electrolyte was casted on top. The electrolyte was allowed to dry in a low-pressure environment. Once a suitable layer of polymer electrolyte had formed on the lithium foil, a second lithium foil was placed on top, along with a spacer, wave spring, and lid. The cell closed for a few minutes under 50 kg cm⁻² of pressure and then tested using a Bio-Logic VSP. The impedance spectra was measured from 10 Hz to 1 MHz frequency using 0.01 V applied disturbance voltage. A scan was taken at each of the following temperatures: 30° C., 50° C., 60° C., 70° C., 80° C., 90° C., 100° C., 110° C., 120° C. This measured polarization resistances were used to determine the overall conductivity of the electrolytes. Equation E1 shows this calculation:

$$\begin{matrix}σ = \frac{L}{{R}_{P} A} & [ S {cm}^{- 1} ]\end{matrix} \qquad Eq . E 1$$

Where Rₚ is the polarization resistance, A is the cross-sectional area of the material and L is the thickness of the material.

Direct current (DC) polarization voltammetry was used to measure the ionic transference number of an electrochemical material. This method is supplemental to the impedance spectroscopy and illustrates the dominant mode of transport within the electrolyte. The method of Doyle and collaborators was used for transport number calculation [M. Doyle, T. F. Fuller, and J. Newman, “The importance of the lithium ion transference number in lithium/polymer cells,” Electrochim. Acta, vol. 39, no. 13, pp. 2073-281 September 1994, doi: 10.1016/0013-4686(94)85091-7]. First, an impedance spectrum is taken on a symmetrical cell and the initial film resistance is noted (R₀). Next, a DC polarization voltage of a few millivolts is applied to the same cell and the initial current and final steady state current is measured. The initial current (I₀) is the current at the first application of the voltage pulse and the steady state current (Iₛ) is the current after the symmetric cell has achieved steady state. The cell undergoes one last impedance spectroscopy measurement to determine the steady state resistance (Rₛ). The transport number is then calculated using Equation E2.

$${t}_{{Li}^{+}} = \frac{{I}_{s} ( Δ V - {I}_{0} {R}_{0} )}{{I}_{0} ( Δ V - {I}_{s} {R}_{s} )} \qquad Eq . E 2$$

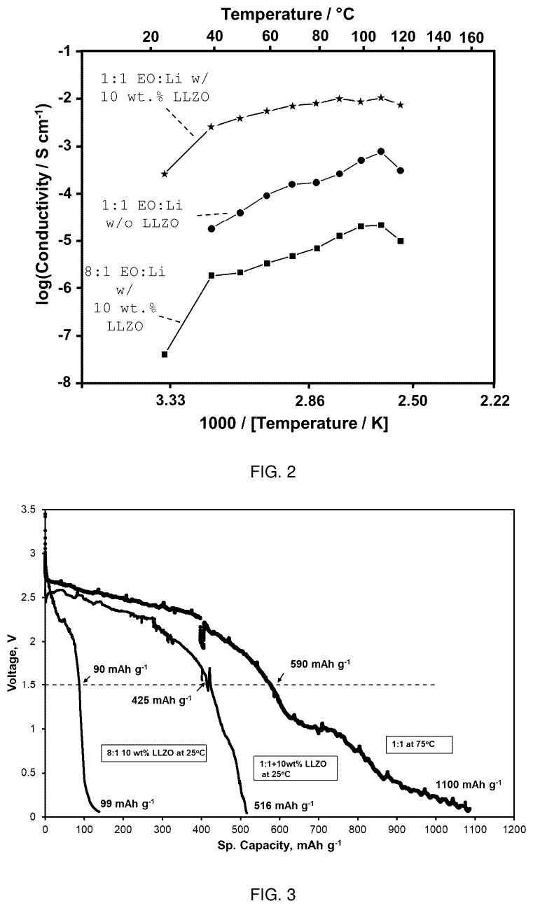

The results are shown in FIG. 2. It can be seen from FIG. 2 that the “polymer in salt” (1:1) electrolytes exhibit conductivity of at least an order of magnitude higher than that of the “salt in polymer” (8:1) electrolyte. The activation energy and pre-exponential factor calculated from the fit to the Arrhenius are summarized in Table 2. The “polymer in salt” (1:1) electrolytes show lower activation energy and higher pre-exponential factor than that of the “salt in polymer” (8:1) EO:Li electrolyte. “Polymer in salt” electrolyte containing LLZO filler exhibits lower activation energy than the 1:1 EO:LiTFSI electrolyte without LLZO, though it has a slightly lower pre-exponential factor. Importantly, the 1:1 LiTFSI-LLZO electrolyte shows conductivity approaching 10⁻³ S cm⁻¹ at room temperature and monotonic temperature dependent behaviour.

TABLE 2
Results of the Arrhenius analysis for the concentration variation.

| | Electrolyte | | |
|---|---|---|---|
| | 1:1 EO:Li with | 1:1 EO:Li with | 8:1 EO:Li with |
| | 0% LLZO | 10% LLZO | 10% LLZO |
| Ea (kJ mol⁻¹) | 42.2 | 31.46 | 49.439 |
| A (S cm⁻¹) | 301 | 294.68 | 120.109 |
| Room temperature | 0.978 ± 0.082 | 0.991 ± 0.126 | 0.803 ± 0.082 |
| Transport number for | | | |
| Li⁺ | | | |

The transport numbers of the electrolytes in Table 2 exceed the numbers published for “salt in polymer” PEO electrolytes, which are expected be 0.5 or lower. However, the 1:1 electrolytes are both highly amorphous and highly concentrated, facilitating good ionic transport.

Constant current discharge curves are shown in FIG. 3. The cells with 1:1 electrolytes have almost 10 times the capacity of the cells with 8:1 electrolytes. Table 3 details the room temperature and 75° C. discharge of full cells at 1 mA g⁻¹ current rate with a CFx cathode for 1:1 EO:Li 0% mass LLZO, the 1:1 EO:Li 10% mass LLZO, and 8:1 EO:Li 10% mass LLZO electrolytes. The higher Li salt concentration of the 1:1 electrolytes show a vast improvement in capacity over the 8:1 electrolytes at room temperature. The ‘polymer-in-salt’ chemistry allows reaching the high capacity of the cell at 75° C.

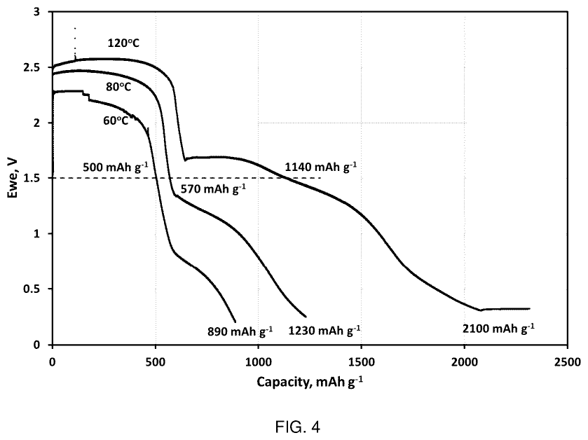

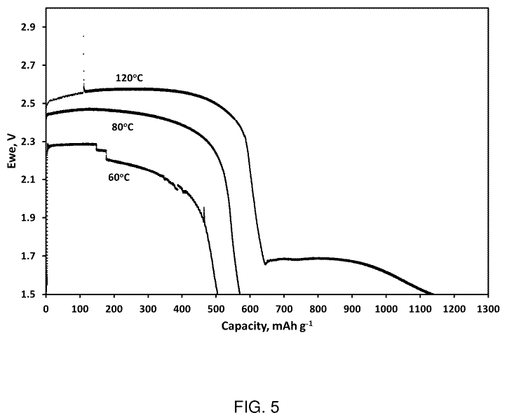

TABLE 3
Capacity and gravimetric specific capacity of the cells
shown in FIG. 4-10, discharged at a rate of 1 mA g⁻¹

| | | | | |
|---|---|---|---|---|
| | | Specific | | Active |
| | Capacity | Capacity | Mass of | material |
| Battery | (mAh) | (mAh g⁻¹) | Cathode(g) | mass(g) |

Room Temperature Discharge

| | | | | |
|---|---|---|---|---|
| 1:1 Electrolyte + | 24.96 | 519.9 | 0.06 ± 0.01 | 0.048 |
| 0% LLZO | | | | |
| 1:1 electrolyte + | 55.25 | 1151 | 0.06 ± 0.01 | 0.048 |
| 10% LLZO | | | | |
| 8:1 Electrolyte + | 0.7948 | 99.35 | 0.04 ± 0.01 | 0.036 |
| 10% LLZO | | | | |

75° C. Discharge

| | | | | |
|---|---|---|---|---|
| 1:1 Electrolyte + | 21.25 | 531.3 | 0.05 ± 0.01 | 0.40 |
| 0% LLZO | | | | |
| 1:1 electrolyte + | 23.09 | 962.2 | 0.03 ± 0.01 | 0.024 |
| 10% LLZO | | | | |
| 8:1 Electrolyte + | 0.6408 | 26.70 | 0.03 ± 0.01 | 0.024 |
| 10% LLZO | | | | |

| | | | |
|---|---|---|---|
| Cathode | Specific Capacity | Mass of | Active material |
| composition | (mAh g⁻¹) | Cathode (g) | mass (g) |

Room Temperature Discharge

| | | | |
|---|---|---|---|
| 1:1 electrolyte + | 520 | 0.06 ± 0.01 | 0.048 |
| 10% LLZO | | | |
| 8:1 Electrolyte + | 99 | 0.04 ± 0.01 | 0.036 |
| 10% LLZO | | | |

75° C. Discharge

| | | | |
|---|---|---|---|
| 1:1 Electrolyte + | 1100 | 0.05 ± 0.01 | 0.40 |
| 0% LLZO | | | |

### Example 2—F-CNT:PEO:LiTFSI “Polymer in Salt” Cell

The cathode was fabricated using 0.07 g F-CNT, 0.02 g PEO (M_{w}≈300,000 g mol⁻¹) and 0.01 g LiTFSI per 1 g N-methyl-2-pyrrolidone (NMP). The F-CNT, PEO and LiTFSI are added to an airtight vial containing the NMP. This is then sonicated using ultrasonic sound waves for 30 min in a water bath at 65° C. Whilst still warm, this cathode mixture is doctor bladed onto carbon-coated aluminium (1 μm carbon on 16 μm aluminium), with a thickness setting of 250 μm. This is then dried in a vacuum oven at 50-60° C. overnight.

To synthesize the “polymer in salt” electrolytes, equal weights of high-molecular weight PEO (e.g. 900,000 g mol⁻¹) and LiTFSI were measured and mixed with anhydrous acetonitrile (Sigma Aldrich) and stirred vigorously until no traces of solid PEO could be detected.

To make a full cell, 19 mm diameter cathode disk was placed in a 2032 cell cap. The electrode was coated with electrolyte by drop casting and dried at 60° C. in protective atmosphere. Lithium foil (16 mm diameter, 1.5 mm thick) was placed on top of the dried electrolyte. Then a stainless steel spacer and a wave spring were placed on top of the lithium foil, and the cell bottom was crimped using 50 kg/cm² of pressure. The cells were allowed to rest overnight before electrochemical testing was undertaken.

Constant current discharge curves of these cells are shown in FIG. 4. The cells were discharged at constant current rate of 15 mA g⁻¹ at 60° C., 80° C. and 120° C.

The specific capacities at cut-off voltages of 1.5 V and 0.25 V are marked on the graph. The first and the second plateaus discharge voltages are monotonically flat and their plateau potential is dependent on the discharge temperature. The capacities reached at lower potentials form slope curves with specific capacities at 0.25 V cut-off potential substantially exceed the theoretical capacity of F-CNT (CFx) material.

Especially in view of their longevity and performance at elevated temperatures, embodiments of the present invention can be used in a variety of wells including oil and gas wells in general, steam/water injection wells, gas injection wells, geothermal thermal wells, carbon capture and storage (CCS) wells, hydrogen storage wells. In particular, the may be used in geothermal wells or production wells for oil or gas production. As such certain embodiments may perform for, for example, 8 years. Indeed, certain embodiments may perform in a well for much longer, such as for 15 to 20 years.

1. An electrochemical cell comprising:
a cathode;
b. an anode; and
c. a solid electrolyte;
wherein the cathode is an electrode comprising a fluorinated carbon nanotube (F-CNT), and
wherein the solid electrolyte comprises an electrolyte component and a filler, the electrolyte component comprising:
i. 50 to 95 wt. % of an alkali metal-containing electrolyte salt, and
ii. 5 to 50 wt. % of a polymer;
wherein the alkali metal-containing electrolyte salt is LiTFSI.

2. The electrochemical cell of claim 1, wherein 0.1 to 25 wt % of the solid electrolyte comprises a filler in the form of an inorganic active stabilizer comprising an alkali metal compound.

3. The electrochemical cell of claim 2, wherein the inorganic active stabilizer comprises at least one of Li_{1.3}Al_{0.3}Ti_{1.7}(PO₄)₃ (LATP), Li₃N, Li₇La₃Zr₂O₁₂ (LLZO), Li_{0.33} La_{0.557}TiO₃ (LLTO), LLZTO, LLAZO, and Li_{1.4}Al_{0.4}Ge_{1.6}(PO₄)₃ (LAGP), an alkali metal garnet, LiAlO₂, Li₁₀GeP₂S₁₂ (LGPS), lithium ion-conducting glass-ceramic (LICGC), Li₂PO₂N (LiPON), Li_{0.5}La_{0.5}TiO₃, Li_{1.4}Al_{0.4}Ti_{1.6}(PO₄)₃, Li_{1.5}Al_{0.5}Ge_{1.5}(PO₄)₃ and Na₃Zr₂Si₂PO₁₂.

4. The electrochemical cell of claim 3, wherein the inorganic active stabilizer comprises Li₇La₃Zr₂O₁₂ (LLZO).

5. The electrochemical cell of claim 1, wherein the polymer comprises poly(ethylene oxide) or poly(vinylidene fluoride).

6. The electrochemical cell of claim 1, wherein the polymer has an average molecular weight (M_{w}) in the range of between about 100,000 and 10,000,000.

7. The electrochemical cell of claim 1, wherein the weight percentage of the salt in the solid electrolyte is at least 50.

8. The electrochemical cell of claim 1, wherein the cathode comprises
i) 50-98 wt. % a fluorinated carbon material;
ii) 1-35 wt. % an alkali metal-containing salt; and
iii) 1-35 wt. % an organic polymer or copolymer.

9. The electrochemical cell of claim 8, wherein the fluorinated carbon material is a fluorinated carbon nanotube (F-CNT).

10. The electrochemical cell of claim 8, wherein the electrode further comprises:
iv) 0.1-15 wt. % of a carbon-based conductive adjuvant.

11. The electrochemical cell of claim 8, wherein the electrode does not further comprise a carbon-based conductive adjuvant.

12. The electrochemical cell of claim 8, wherein the organic polymer or copolymer of the cathode and the polymer of the solid electrolyte comprise the same material.

13. The electrochemical cell of claim 8, wherein the alkali metal-containing salt of the cathode and the alkali metal-containing electrolyte salt of the electrolyte comprise the same material.

14. The electrochemical cell of claim 1, wherein the cathode further comprises an inorganic active stabilizer comprising an alkali metal compound.

15. The electrochemical cell of claim 1, wherein the solid electrolyte is formed as a layer having a thickness of least 5 microns, optionally at least 25 microns, more optionally at least 50 microns.

16. The electrochemical cell of claim 1, wherein the anode comprises at least one of lithium and an alloy thereof.

17. The electrochemical cell of claim 1, shaped into at least one of a bobbin shape and a spiral wound shape.

18. A container containing an electrochemical cell comprising:
a cathode;
b. an anode; and
c. a solid electrolyte;
wherein the cathode is an electrode comprising a fluorinated carbon nanotube (F-CNT);
wherein the solid electrolyte comprises an electrolyte component and a filler, the electrolyte component comprising:
i. 50 to 95 wt. % of an alkali metal-containing electrolyte salt, and
ii. 5 to 50 wt. % of a polymer;
wherein the alkali metal-containing electrolyte salt is LiTFSI, and
wherein the container defines a space adjacent to the cell to allow for thermal expansion thereof.

19. A system comprising an electrochemical cell comprising:
a cathode;
b. an anode; and
c. a solid electrolyte;
wherein the cathode is an electrode comprising a fluorinated carbon nanotube (F-CNT), and
wherein the solid electrolyte comprises an electrolyte component and a filler, the electrolyte component comprising:
i. 50 to 95 wt. % of an alkali metal-containing electrolyte salt, and
ii. 5 to 50 wt. % of a polymer;
wherein the alkali metal-containing electrolyte salt is LiTFSI, and
coupled with a power control circuit,
wherein the power control circuit is operable to discharge the electrochemical cell at a first voltage and at a second voltage;
wherein the second voltage is lower than the first voltage; and
output terminals electrically connected to the power control circuit for providing the output voltage to a load.

20. The system according to claim 19, wherein the second voltage is at least 20%.

21. The system according to claim 19, wherein the power control circuit is a DC-to-DC voltage convertor.

22. A method of using an electrochemical cell comprising:
a cathode;
b. an anode; and
c. a solid electrolyte;
wherein the cathode is an electrode comprising a fluorinated carbon nanotube (F-CNT), and
wherein the solid electrolyte comprises an electrolyte component and a filler, the electrolyte component comprising:
i. 50 to 95 wt. % of an alkali metal-containing electrolyte salt, and
ii. 5 to 50 wt. % of a polymer;
wherein the alkali metal-containing electrolyte salt is LiTFSI, at a temperature of greater than about 65° C.

23. A method of using an electrochemical cell or system as claimed in claim 22 for powering a tool in a subterranean well.
